(19) United States
(12) Patent Application Publication
(10) Pub. No.: US 2025/0316038 A1
(43) Pub. Date: Oct. 9, 2025

(54) POINT CLOUD DECODER WITH 6D POSE ESTIMATION

(71) Applicant: InterDigital VC Holdings, Inc., Wilmington, DE (US)

(72) Inventors: Junghyun Ahn, New York, NY (US); Jiahao Pang, Plainsboro, NJ (US); Muhammad Asad Lodhi, Highland Park, NJ (US); Dong Tian, Boxborough, MA (US)

(21) Appl. No.: 18/628,445

(22) Filed: Apr. 5, 2024

(51) Int. Cl. G06T 19/20; G06T 7/73; G06T 9/00; G06T 17/00

(52) U.S. Cl. CPC G06T 19/20; G06T 7/73; G06T 9/002; G06T 17/00; G06T 2207/10028; G06T 2207/20081; G06T 2207/20084; G06T 2210/56; G06T 2219/2004; G06T 2219/2016

(57) ABSTRACT

Some embodiments of a method may include: accessing a feature map, wherein the feature map is generated by a preceding set of neural network layers; reconstructing a set of local points with a first neural network by using the feature map; estimating a six-dimensional (6D) pose with a second neural network by using the feature map; transforming, by the estimated 6D pose, each local coordinate extracted from the set of local points; and outputting the reconstructed point cloud.

### INCORPORATION BY REFERENCE

The present application incorporates by reference in their entirety the following applications: U.S. Provisional Patent Application Ser. No. 63/536,321, entitled “AN ENHANCED FEATURE PROCESSING FOR POINT CLOUD COMPRESSION BASED ON FEATURE DISTRIBUTION LEARNING” and filed Sep. 1, 2023 (“321 application”); and U.S. Provisional Patent Application Ser. No. 63/543,466, entitled “OCTREE FEATURE FOR DEEP-FEATURE BASED POINT CLOUD COMPRESSION” and filed Oct. 10, 2023 (“466 application”).

### BACKGROUND

Point cloud is a universal data format across several business domains from autonomous driving, robotics, AR/VR, civil engineering, computer graphics, to the animation/movie industry. 3D LiDAR sensors have been deployed in self-driving cars, and affordable LiDAR sensors are released from Velodyne Velabit, Apple iPad Pro 2020 and Intel RealSense LiDAR camera L515. With advances in sensing technologies, 3D point cloud data is becoming more practical than ever and is expected to be an ultimate enabler in the applications mentioned.

Point cloud data is also believed to consume a large portion of network traffic, e.g., among connected cars over 5G network, and immersive communications (VR/AR). Efficient representation formats are necessary for point cloud understanding and communication. In particular, raw point cloud data needs to be properly organized and processed for the purposes of world modeling & sensing. Compression on raw point clouds is essential when storage and transmission of the data are required in the related scenarios.

Furthermore, point clouds may represent a sequential scan of the same scene, which contains multiple moving objects. They are called dynamic point clouds as compared to static point clouds captured from a static scene or static objects. Dynamic point clouds are typically organized into frames, with different frames being captured at different times. Dynamic point clouds may require the processing and compression to be in real-time or with low delay.

### SUMMARY

A first example method in accordance with some embodiments may include: accessing a feature map, wherein the feature map is generated by a preceding set of neural network layers; reconstructing a set of local points with a first neural network by using the feature map; estimating a six-dimensional (6D) pose with a second neural network by using the feature map; transforming, by the estimated 6D pose, each local coordinate extracted from the set of local points; and outputting the reconstructed point cloud.

For some embodiments of the first example method, the feature map is a block feature map, estimating the 6D pose includes estimating the 6D pose on a per block basis, and transforming each extracted local coordinate includes transforming the 6D pose on a per block basis.

For some embodiments of the first example method, the first neural network is a learning-based surface reconstruction-type neural network.

For some embodiments of the first example method, reconstructing the set of local points includes: selecting a first set from a group of grid points; repeating a loop based on a quantity of points in the feature map: concatenating the first set and a subset of a block feature vector to generate a concatenated set of points; and passing the concatenated set of points through the first neural network to generate the first set for a next pass through the loop; and outputting, as the set of local points, the first set from a last pass through the loop.

For some embodiments of the first example method, estimating the 6D pose includes: estimating, for each block of the plurality of blocks associated with the feature map, an array of translational matrices; and estimating, for each block of a plurality of blocks associated with the feature map, an array of rotational matrices.

For some embodiments of the first example method, transforming each local coordinate extracted from the set of local points includes: translating at least one of the local points using the array of translational matrices; and rotating at least one of the local points using the array of rotational matrices.

For some embodiments of the first example method, transforming each local coordinate extracted from the set of local points includes: re-centering, using the array of translational matrices, at least one of the local points; and aligning, using the array of rotational matrices, at least of the local points.

Some embodiments of the first example method may further include determining a loss function using at least one of the array of translational matrices and the array of rotational matrices.

For some embodiments of the first example method, estimating the array of translational matrices includes: performing at least one convolutional layer process on the feature map; and performing at least one multi-layer perceptron (MLP) process on an output of the at least one convolutional layer process to output the array of translational matrices.

For some embodiments of the first example method, estimating the array of rotational matrices includes: performing at least one convolutional layer process on the feature map; and performing at least one multi-layer perceptron (MLP) process on an output of the at least one convolutional layer process to output the array of rotational matrices.

For some embodiments of the first example method, estimating the array of translational matrices includes using a translation estimation process.

For some embodiments of the first example method, estimating the array of rotational matrices includes using a rotation estimation process.

For some embodiments of the first example method, estimating the 6D pose includes performing a dimensionality reduction technique.

Some embodiments of the first example method may further include entropy decoding a bitstream to generate the feature map.

Some embodiments of the first example method may further include performing a feature aggregation process on the feature map.

For some embodiments of the first example method, the feature aggregation process includes: performing at least one convolutional layer process; and performing at least one rectifier linear unit (ReLU) process.

A first example apparatus in accordance with some embodiments may include: a processor; and a memory, the memory storing instructions operative, when executed by the processor, to cause the apparatus to: access a feature map, wherein the feature map is generated by a preceding set of neural network layers; reconstruct local points with a first neural network by using the feature map; estimate a 6D pose with a second neural network by using the feature map; transform, by the estimated 6D pose, each local coordinate extracted from the set of local points; and output the reconstructed point cloud.

A second example method in accordance with some embodiments may include: entropy decoding a bitstream to obtain a feature map; performing a surface reconstruction to generate a set of local points using the feature map; estimating a 6D pose with a neural network by using the feature map; transforming, by the estimated 6D pose, each local point extracted from the set of local points; and outputting the reconstructed point cloud.

For some embodiments of the second example method, the feature map is a block feature map, estimating the 6D pose includes estimating the 6D pose on a per block basis, and transforming each extracted local coordinate includes transforming the 6D pose on a per block basis.

For some embodiments of the second example method, the neural network is a learning-based surface reconstruction-type neural network.

### BRIEF DESCRIPTION OF THE DRAWINGS

FIG. 1 is a system diagram illustrating an example set of interfaces for a system according to some embodiments.

FIG. 2 is a process diagram illustrating an example learning-based point cloud compression (PCC) framework according to some embodiments.

FIG. 3 is a process diagram illustrating an example FoldingNet decoder in a PCC framework according to some embodiments.

FIG. 4 is a process diagram illustrating an example block upsampling process in a FoldingNet decoder according to some embodiments.

FIG. 5 is a process diagram illustrating an example block-wise surface reconstruction process according to some embodiments.

FIG. 6 is a schematic illustration showing an example expanded block feature vector concatenation to grid positions according to some embodiments.

FIG. 7 is a process diagram illustrating an example expanded block upsampling to point cloud frame process according to some embodiments.

FIG. 8 is a schematic illustration showing an example translation of the center of block points to the origin of a local 3D space according to some embodiments.

FIG. 9 is a schematic illustration showing an example rotation of translated points towards the axes of a local 3D space according to some embodiments.

FIG. 10 is a process diagram illustrating an example determination of block surface alignment ground truth for a training process according to some embodiments.

FIG. 11 is a process diagram illustrating an example rotation/translation decoder framework with an example surface reconstruction framework, for example a FORT-Net decoder framework, according to some embodiments.

FIG. 12 is a process diagram illustrating an example block-wise surface reconstruction with inversed block alignment according to some embodiments.

FIG. 13 is a process diagram illustrating an example R-Net block according to some embodiments.

FIG. 14 is a process diagram illustrating an example T-Net block according to some embodiments.

FIG. 15 is a process diagram illustrating an example Inception-ResNet block for feature aggregation according to some embodiments.

FIG. 16 is a flowchart illustrating an example process for reconstructing a point cloud according to some embodiments.

The entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—may only properly be read as being constructively preceded by a clause such as “In at least one embodiment, . . . ” For brevity and clarity of presentation, this implied leading clause is not repeated ad nauseum in the detailed description.

### DETAILED DESCRIPTION

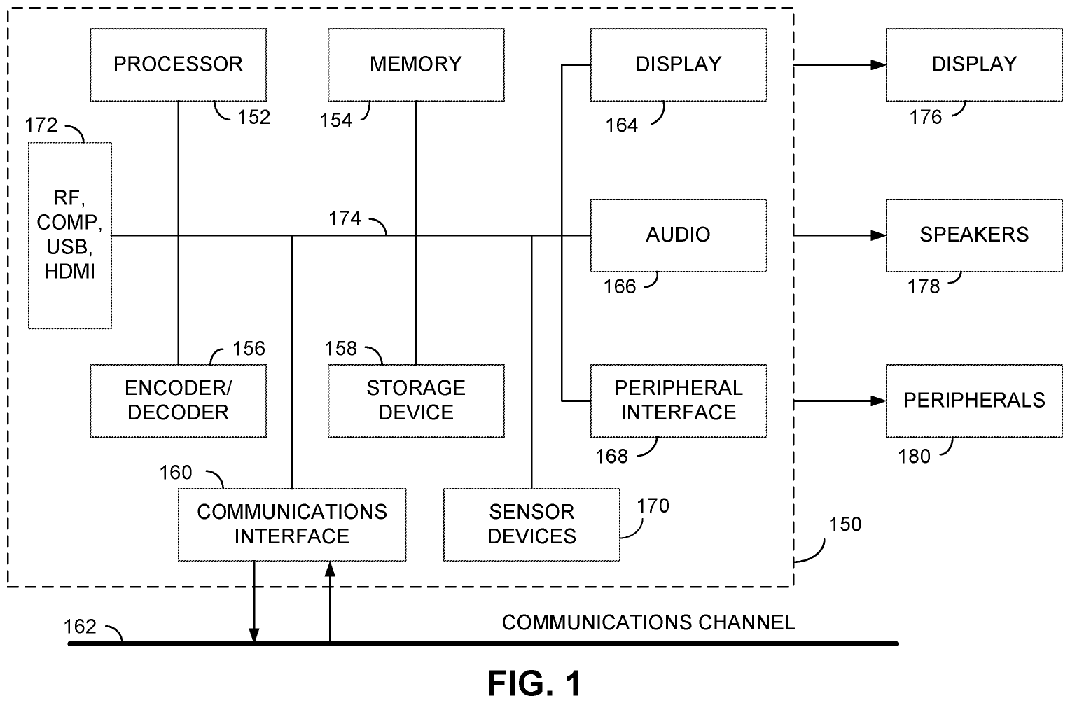

FIG. 1 is a system diagram illustrating an example set of interfaces for a system according to some embodiments. An extended reality display device, together with its control electronics, may be implemented using a system such as the system of FIG. 1. System 150 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 150, singly or in combination, can be embodied in a single integrated circuit (IC), multiple ICs, and/or discrete components. For example, in at least one embodiment, the processing and encoder/decoder elements of system 150 are distributed across multiple ICs and/or discrete components. In various embodiments, the system 150 is communicatively coupled to one or more other systems, or other electronic devices, via, for example, a communications bus or through dedicated input and/or output ports. In various embodiments, the system 150 is configured to implement one or more of the aspects described in this document.

The system 150 includes at least one processor 152 configured to execute instructions loaded therein for implementing, for example, the various aspects described in this document. Processor 152 may include embedded memory, input output interface, and various other circuitries as known in the art. The system 150 includes at least one memory 154 (e.g., a volatile memory device, and/or a non-volatile memory device). System 150 may include a storage device 158, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 158 can include an internal storage device, an attached storage device (including detachable and non-detachable storage devices), and/or a network accessible storage device, as non-limiting examples.

System 150 includes an encoder/decoder module 156 configured, for example, to process data to provide an encoded video or decoded video, and the encoder/decoder module 156 can include its own processor and memory. The encoder/decoder module 156 represents module(s) that can be included in a device to perform the encoding and/or decoding functions. As is known, a device can include one or both of the encoding and decoding modules. Additionally, encoder/decoder module 156 can be implemented as a separate element of system 150 or can be incorporated within processor 152 as a combination of hardware and software as known to those skilled in the art.

Program code to be loaded onto processor 152 or encoder/decoder 156 to perform the various aspects described in this document can be stored in storage device 158 and subsequently loaded onto memory 154 for execution by processor 152. In accordance with various embodiments, one or more of processor 152, memory 154, storage device 158, and encoder/decoder module 156 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 152 and/or the encoder/decoder module 156 is used to store instructions and to provide working memory for processing that is needed during encoding or decoding. In other embodiments, however, a memory external to the processing device (for example, the processing device can be either the processor 152 or the encoder/decoder module 152) is used for one or more of these functions. The external memory can be the memory 154 and/or the storage device 158, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 150 can be provided through various input devices as indicated in block 172. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1C, include composite video.

In various embodiments, the input devices of block 172 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 150 to other electronic devices across USB and/or HDMI connections. It is to be understood that various aspects of input processing, for example, Reed-Solomon error correction, can be implemented, for example, within a separate input processing IC or within processor 152 as necessary. Similarly, aspects of USB or HDMI interface processing can be implemented within separate interface ICs or within processor 152 as necessary. The demodulated, error corrected, and demultiplexed stream is provided to various processing elements, including, for example, processor 152, and encoder/decoder 156 operating in combination with the memory and storage elements to process the datastream as necessary for presentation on an output device.

Various elements of system 150 can be provided within an integrated housing, Within the integrated housing, the various elements can be interconnected and transmit data therebetween using suitable connection arrangement 174, for example, an internal bus as known in the art, including the Inter-IC (12C) bus, wiring, and printed circuit boards.

The system 150 includes communication interface 160 that enables communication with other devices via communication channel 162. The communication interface 160 can include, but is not limited to, a transceiver configured to transmit and to receive data over communication channel 162. The communication interface 160 can include, but is not limited to, a modem or network card and the communication channel 162 can be implemented, for example, within a wired and/or a wireless medium.

Data is streamed, or otherwise provided, to the system 150, in various embodiments, using a wireless network such as a Wi-Fi network, for example IEEE 802.11 (IEEE refers to the Institute of Electrical and Electronics Engineers). The Wi-Fi signal of these embodiments is received over the communications channel 162 and the communications interface 160 which are adapted for Wi-Fi communications. The communications channel 162 of these embodiments is typically connected to an access point or router that provides access to external networks including the Internet for allowing streaming applications and other over-the-top communications. Other embodiments provide streamed data to the system 150 using a set-top box that delivers the data over the HDMI connection of the input block 172. Still other embodiments provide streamed data to the system 150 using the RF connection of the input block 172. As indicated above, various embodiments provide data in a non-streaming manner. Additionally, various embodiments use wireless networks other than Wi-Fi, for example a cellular network or a Bluetooth network.

The system 150 can provide an output signal to various output devices, including a display 176, speakers 178, and other peripheral devices 180. The display 176 of various embodiments includes one or more of, for example, a touchscreen display, an organic light-emitting diode (OLED) display, a curved display, and/or a foldable display. The display 176 can be for a television, a tablet, a laptop, a cell phone (mobile phone), or other device. The display 176 can also be integrated with other components (for example, as in a smart phone), or separate (for example, an external monitor for a laptop). The other peripheral devices 180 include, in various examples of embodiments, one or more of a stand-alone digital video disc (or digital versatile disc) (DVR, for both terms), a disk player, a stereo system, and/or a lighting system. Various embodiments use one or more peripheral devices 180 that provide a function based on the output of the system 150. For example, a disk player performs the function of playing the output of the system 150.

In various embodiments, control signals are communicated between the system 150 and the display 176, speakers 178, or other peripheral devices 180 using signaling such as AV.Link, Consumer Electronics Control (CEC), or other communications protocols that enable device-to-device control with or without user intervention. The output devices can be communicatively coupled to system 150 via dedicated connections through respective interfaces 164, 166, and 168. Alternatively, the output devices can be connected to system 150 using the communications channel 162 via the communications interface 160. The display 176 and speakers 178 can be integrated in a single unit with the other components of system 150 in an electronic device such as, for example, a television. In various embodiments, the display interface 164 includes a display driver, such as, for example, a timing controller (T Con) chip.

The display 176 and speaker 178 can alternatively be separate from one or more of the other components, for example, if the RF portion of input 172 is part of a separate set-top box. In various embodiments in which the display 176 and speakers 178 are external components, the output signal can be provided via dedicated output connections, including, for example, HDMI ports, USB ports, or COMP outputs.

The system 150 may include one or more sensor devices 168. Examples of sensor devices that may be used include one or more GPS sensors, gyroscopic sensors, accelerometers, light sensors, cameras, depth cameras, microphones, and/or magnetometers. Such sensors may be used to determine information such as user's position and orientation. Where the system 150 is used as the control module for an extended reality display (such as control modules 124, 132), the user's position and orientation may be used in determining how to render image data such that the user perceives the correct portion of a virtual object or virtual scene from the correct point of view. In the case of head-mounted display devices, the position and orientation of the device itself may be used to determine the position and orientation of the user for the purpose of rendering virtual content. In the case of other display devices, such as a phone, a tablet, a computer monitor, or a television, other inputs may be used to determine the position and orientation of the user for the purpose of rendering content. For example, a user may select and/or adjust a desired viewpoint and/or viewing direction with the use of a touch screen, keypad or keyboard, trackball, joystick, or other input. Where the display device has sensors such as accelerometers and/or gyroscopes, the viewpoint and orientation used for the purpose of rendering content may be selected and/or adjusted based on motion of the display device.

The embodiments can be carried out by computer software implemented by the processor 152 or by hardware, or by a combination of hardware and software. As a non-limiting example, the embodiments can be implemented by one or more integrated circuits. The memory 154 can be of any type appropriate to the technical environment and can be implemented using any appropriate data storage technology, such as optical memory devices, magnetic memory devices, semiconductor-based memory devices, fixed memory, and removable memory, as non-limiting examples. The processor 152 can be of any type appropriate to the technical environment, and can encompass one or more of microprocessors, general purpose computers, special purpose computers, and processors based on a multi-core architecture, as non-limiting examples.

This application discusses point cloud compression and processing. The field aims to develop tools for compression, analysis, interpolation, representation and understanding of input signals, such as point clouds.

### Point Cloud Data Format

Point cloud is a universal data format across several business domains from autonomous driving, robotics, AR/VR, civil engineering, computer graphics, to the animation/movie industry. 3D LiDAR sensors have been deployed in self-driving cars, and affordable LiDAR sensors are released from Velodyne Velabit, Apple iPad Pro 2020 and Intel RealSense LiDAR camera L515. With advances in sensing technologies, 3D point cloud data is becoming more practical than ever and is expected to be an ultimate enabler in the applications mentioned.

Point cloud data is also believed to consume a large portion of network traffic, e.g., among connected cars over 5G network, and immersive communications (VR/AR). Efficient representation formats are necessary for point cloud understanding and communication. In particular, raw point cloud data needs to be properly organized and processed for the purposes of world modeling & sensing. Compression on raw point clouds is essential when storage and transmission of the data are required in the related scenarios.

Furthermore, point clouds may represent a sequential scan of the same scene, which contains multiple moving objects. They are called dynamic point clouds as compared to static point clouds captured from a static scene or static objects. Dynamic point clouds are typically organized into frames, with different frames being captured at different times. Dynamic point clouds may require the processing and compression to be in real-time or with low delay.

### Point Cloud Data Use Cases

The automotive industry and autonomous car are domains in which point clouds may be used. Autonomous cars should be able to “probe” their environment to make good driving decisions based on the reality of their immediate surroundings. Typically, sensors like LiDARs produce (dynamic) point clouds that are used by the perception engine. These point clouds are not intended to be viewed by human eyes, and they are typically sparse, not necessarily colored, and dynamic with a high frequency of capture. They may have other attributes, like the reflectance ratio provided by the LiDAR because this attribute is indicative of the material of the sensed object, and this attribute may help in making a decision.

Virtual Reality (VR) and immersive worlds have become a hot topic and are foreseen by many as the future of 2D flat video. The viewer is immersed in an environment all around the viewer as opposed to standard TV where the viewer may look only at the virtual world in front of the viewer. There are several gradations in the immersivity depending on the freedom of the viewer in the environment. Point clouds are a good format candidate to distribute VR worlds. They may be static or dynamic and are typically of average size, with, e.g., no more than millions of points at a time.

Point clouds also may be used for various purposes, such as cultural heritage/buildings in which objects like statues or buildings are scanned in 3D to share the spatial configuration of the object without sending or visiting the statues or buildings. Also, point clouds offer a way to ensure preservation of the knowledge of the object in case the original object, for instance, is destroyed by an earthquake. Such point clouds are typically static, colored, and huge.

Another use case is in topography and cartography in which using 3D representations, maps are not limited to the plane and may include the relief. Google Maps is a good example of 3D maps but is understood to use meshes instead of point clouds. Nevertheless, point clouds may be a suitable data format for 3D maps, and such point clouds are typically static, colored, and huge.

World modeling and sensing via point clouds may be a technology that allows machines to gain knowledge about the 3D world around them, which may be used by the applications discussed above.

3D point cloud data include discrete samples of the surfaces of objects or scenes. A huge number of points may be used to fully represent the real world with point samples. For instance, a typical VR immersive scene contains millions of points, while point clouds typically contain hundreds of millions of points. Therefore, the processing of such large-scale point clouds may be computationally expensive, especially for consumer devices, such as smartphones, tablets, and automotive navigation systems, that have limited computational power.

The first step for any processing or inference on the point cloud is to have efficient storage methodologies. To store and process the input point cloud with affordable computational cost, the point cloud may be down-sampled first, where the down-sampled point cloud summarizes the geometry of the input point cloud while having much fewer points. The down-sampled point cloud may be fed to a machine task for further consumption. However, further reduction in storage space may be achieved by converting the raw point cloud data (original or down sampled) into a bitstream through entropy coding techniques for lossless compression.

In addition to lossless coding, many scenarios for lossy coding seek significantly improved compression ratios while maintaining the induced distortion under certain quality levels. To achieve a less lossy coding, an efficient point feature extractor may improve the accuracy of the reconstruction within the given resource budget.

One additional challenge is efficient interpretation of the sparse nature of the 3D point clouds compared to regularly arranged 2D pixel samples for the image. To handle this issue, a sparse convolution method has been introduced in Choy, C., et al., 4D Spatio-Temporal ConvNets: Minkowski Convolutional Neural Networks, PROC. OF CONF. ON COMP. VISION AND PATTERN RECOGNITION (CVPR) (2019). Based on so-called sparse CNN, the learning-based point cloud compression (PCC) becomes one of the most interesting topics in the computer vision and machine learning communities.

### Learning-Based Dense Point Cloud Compression

Among lossy coding schemes, different strategies may be considered based on the density of input point clouds. Two major categories may be considered: dense point clouds and sparse point clouds. A sparse point cloud is more suitable for an application on a larger space, such as autonomous driving. On the other hand, a dense point cloud may be used in immersive applications in a relatively smaller space for communication between persons and interactions with objects in a 3D virtual world.

In general, a dense point cloud contains more points in each given space, which makes the coding algorithm simpler to approach with a voxel-based method as the downsampling equally aggregates points in each downsampled block. Wang, Jianqiang, et al., Multiscale Point Cloud Geometry Compression, 2021 DATA COMPRESSION CONF. (DCC) 73-82, IEEE (2021) describes such a voxel-based method. On the contrary, in the upsampling stage, a classification network is additionally connected to estimate the occupancy of each upsampled points. However, as a downside, this method may over-smooth the surface that needs to be reconstructed.

Understanding the surface information within a learning-based point cloud compression (PCC) framework is an additional plus to improve coding performance. Especially, the detail of surface in a dense point cloud may contain high frequency information, which makes difficult to reconstruct in an example voxel-based PCC framework. A combination of voxel-based downsampling in the encoder along with a surface structure embedded point-based upsampling approach in the decoder may improve the coding performance. This goal is pursued with this application.

Some example voxel-based PCC methods for dense point cloud do not naturally infer a surface representation of the shape during the decoding stage. The FoldingNet algorithm, which is described in Yang, Y., et al., FoldingNet: Point Cloud Auto-Encoder via Deep Grid Deformation, PROC. OF IEEE CONF. ON COMP. VISION AND PATTERN RECOGNITION (CVPR) (2018), is a neural network architecture for learning to generate the surface of 3D shapes. A folding-based reconstruction block deforms a canonical 2D grid onto the underlying 3D object surface of a point cloud, achieving low reconstruction errors, even for objects with delicate structures.

This folding-based reconstruction uses two consecutive, 3-layer perceptrons to warp a fixed 2D grid into the shape of the input point cloud. The first perceptron folds the 2D grid to 3D space, and the second perceptron folds inside the 3D space. Each folding operation conducts a relatively simple operation, and the composition of the two folding operations may produce elaborate surface shapes.

The FoldingNet architecture is presented to improve the object classification problem. However, due to the simplicity, efficiency, and surface-inferring approach of the FoldingNet architecture, applying the architecture to a learning-based PCC framework for dense point cloud offers a promising coding gain.

Described herein is a learning-based point cloud decoding (upsampling) method specially designed for dense point cloud reconstruction. Based on the FoldingNet architecture, the surface representation, as considered from the decoder, may better preserve the detail of a surface during an inference process.

### FoldingNet Decoder

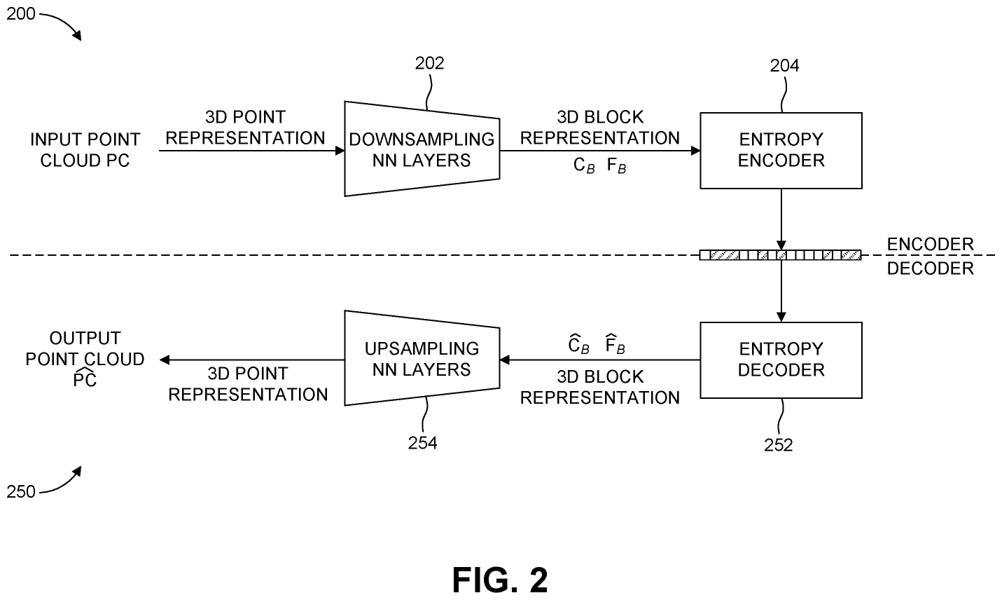

FIG. 2 is a process diagram illustrating an example learning-based point cloud compression (PCC) framework according to some embodiments. As illustrated in FIG. 2, an example learning-based point cloud compression (PCC) encoder 200 downsamples 202 a point cloud, then extracts features for each downsampled point. This block, representing a point cloud coupled with a feature vector, is entropy encoded 204 and packed into a bitstream sent to a PCC decoder 250. In the PCC decoder 250, the bitstream is entropy decoded 252 to generate sets of multiple points belonging to each block, These blocks are passed through a neural network (NN) upsampling layers block 254, such as a deconvolution block, to reconstruct the point cloud. However, a more traditional example block upsampling module may, for example, lack understanding of surface information, which is one of major properties in a dense point cloud. The FoldingNet architecture may be used for reconstructing point clouds because such an architecture approximates a 3D surface from a 2D grid. In some embodiments, the PCC encoder 200 may include a decoder similar to PCC decoder 250.

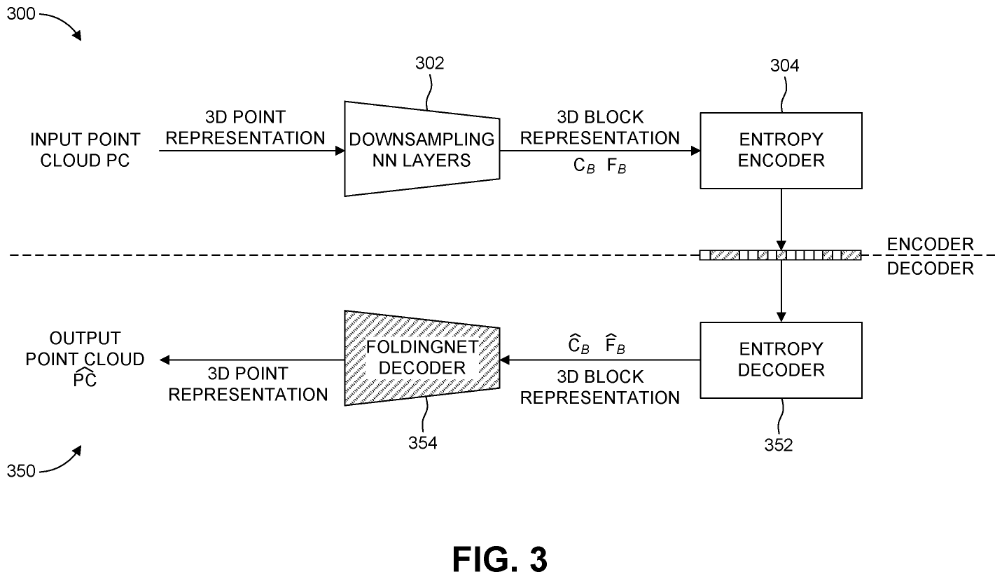

FIG. 3 is a process diagram illustrating an example FoldingNet decoder in a PCC framework according to some embodiments. In a PCC encoder 300, an input point cloud is downsampled 302 and then passed through an entropy encoder 304. The output bitstream is received by a PCC decoder 350 and passed through an entropy decoder 352. In some embodiments, the PCC encoder 300 may include a decoder similar to PCC decoder 350.

Comparing FIGS. 2 and 3, the point cloud upsampling block 254 of FIG. 2 may, in accordance with some embodiments, be replaced with an example neural network decoder such FoldingNet Decoder 354. In accordance with some embodiments, The FoldingNet Decoder 354 takes the reconstructed 3D block coordinates (Ĉ_{B}) and the corresponding feature map (\hat{F}_{B}) as inputs. The \hat{F}_{B} is a collection of feature vector \hat{F}_{B} (b=1 . . . . N_{B}), where N_{B} is the number of downsampled points (occupied blocks). Each feature vector corresponds to a unique block coordinate Ĉ_{b} for b=1 . . . . N_{B}.

The FoldingNet decoder is a specific example of a neural network block that estimates surface of point clouds from a given space (a block in this case). The FoldingNet decoder takes a global feature as an input and concatenates the global feature to each 2D point of a given 2D grid. A 2-stage neural network process deforms a regular 2D grid to a surface in the given 3D space.

Although a “FoldingNet decoder” is shown in FIG. 3 and is discussed herein, it will be understood that a FoldingNet decoder (in presented examples and in accordance with some embodiments) is an example of, e.g., an learning-based surface reconstruction type neural network, and other decoders and configurations are contemplated in accordance with some embodiments.

### Block Upsampling

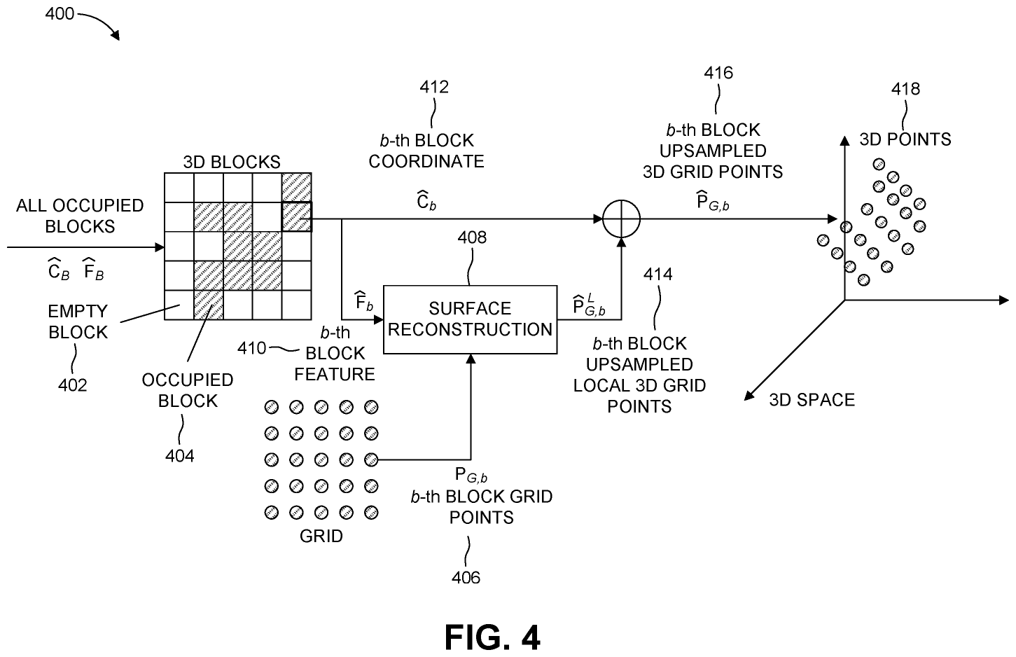

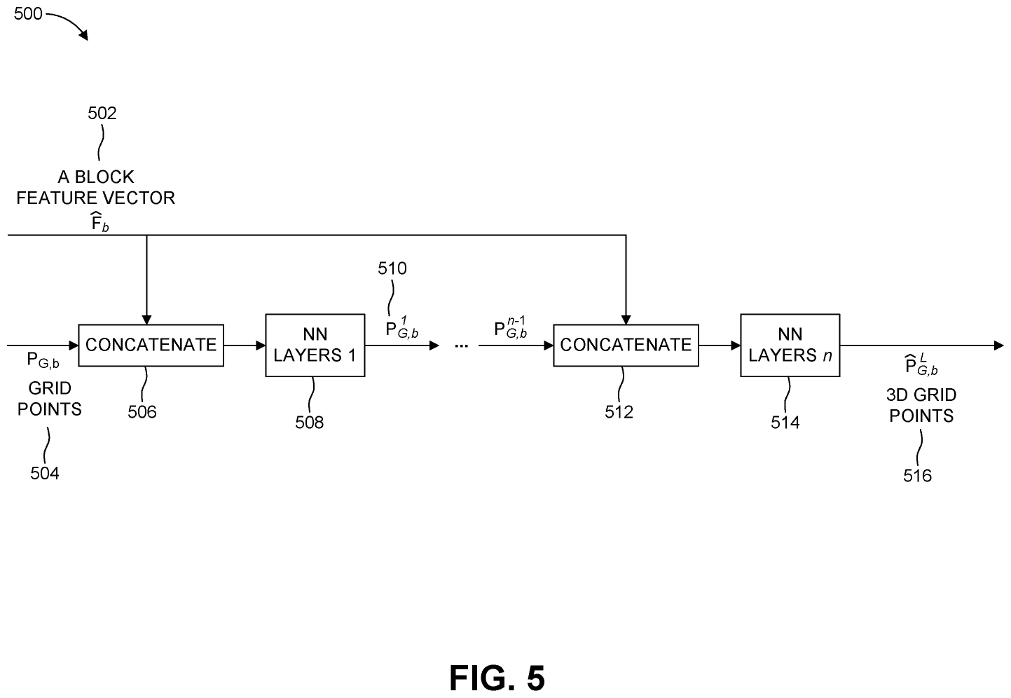

FIG. 4 is a process diagram illustrating an example block upsampling process in a FoldingNet decoder according to some embodiments. FIG. 4 illustrates more detail regarding an example block upsampling process 400, which is inside the FoldingNet decoder of FIG. 3. FIG. 4 focuses on surface reconstruction of a single occupied block b. The left side of FIG. 4 shows a collection of 3D blocks, which includes empty blocks 402 and occupied blocks 404. The input Ĉ_{b} 412 consists of only the occupied blocks 404. The input \hat{F}_{b} 410 has feature vectors corresponding to each occupied block 404. The empty blocks 402 are shown to explain the entire block space. The feature vector Ĉ_{b} 410 attached to the occupied block b is concatenated with grid \hat{F}_{b}, which is allocated for upsampling of the b-th block. The surface reconstruction block 408 performs the upsampling. See FIG. 5 for example details on the concatenation. Ĉ_{b} 412 is the 3D coordinate (XYZ position) of the b-th block. The grid P_{G,b} is a collection of grid points P_{g,b} for g=1 . . . . N_{G}, where N_{G} is the total number of the grid points. P_{g,b} is an array of multiple 2D grid positions associated with the b-th block. Each 3D block is associated with a 2D grid. The surface reconstruction block 408 takes both \hat{F}_{b} 410 and P_{G,b} 406 as inputs and outputs a deformed 3D grid

$${\hat{P}}_{G , b}^{L}$$

414 III a local Ou Space. To transform this local surface to the global 3D space, the b-th block position (or coordinate) Ĉ_{b} 412 is added (⊕ operation) to every local grid point

$${\hat{P}}_{g , b}^{L}$$

414 for g=1 . . . . N_{G} to generate the b-th block of upsampled 3D grid points \hat{P}_{G,b} 416, which are shown in FIG. 4 as a collection of 3D points 418.

### Surface Reconstruction

FIG. 5 is a process diagram illustrating an example block-wise surface reconstruction process according to some embodiments. In the surface reconstruction block 500, a series of neural network (NN) layers 508, 514 are connected sequentially. As illustrated in FIG. 5, for each step, the block feature vector \hat{F}_{b} 502 is concatenated 506, 512 with the grid points 504, 510 and refines the grid points via a set of NN layers. The final local 3D surface of 3D gird points,

$${\hat{P}}_{g , b}^{L} ,$$

516 is approximated at the final step.

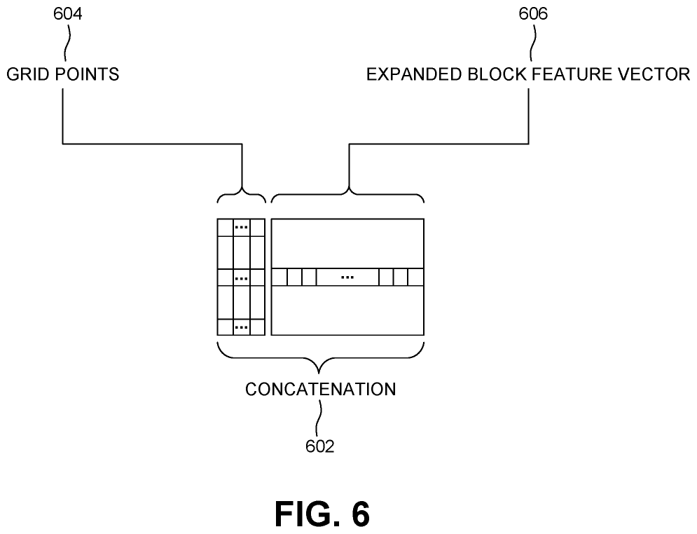

FIG. 6 is a schematic illustration showing an example expanded block feature vector concatenation to grid positions according to some embodiments. The concatenation 602 takes the expanded block feature vector, f_{b} 606, and the grid points 604 as inputs and proceeds with the concatenation as depicted in FIG. 6. The same feature vector \hat{F}_{b} is concatenated to each grid point.

### Frame Upsampling

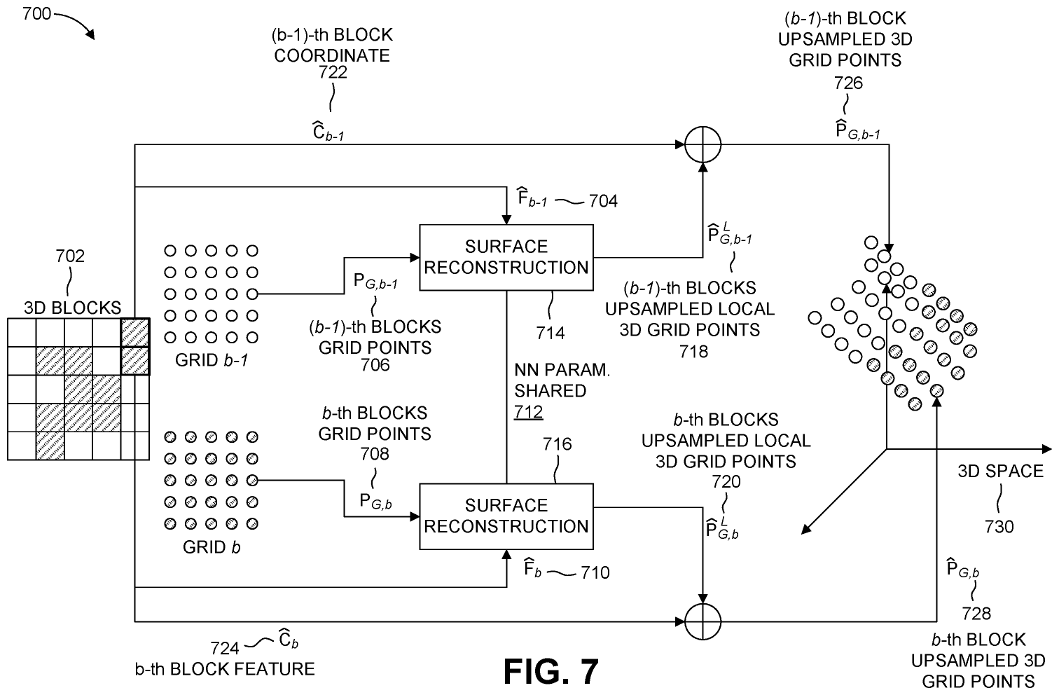

FIG. 7 is a process diagram illustrating an example expanded block upsampling to point cloud frame process according to some embodiments.

A block upsampling process 700 may be expanded to an entire point cloud frame of 3D blocks 702. As depicted in FIG. 7, each block (e.g., (b−1)-th or b-th) reconstructs its local surface through the same surface reconstruction block 714, 716 with different inputs. In accordance with some embodiments, for the simplicity of design and for making the neural network (NN) block able to synthesize general cases, the network parameters 712 of the NN layers in surface reconstruction blocks 714, 716 are shared between different blocks. In other embodiments, some or all network parameters may not be shared between different respective blocks.

For example, for some embodiments, as the number of blocks in a frame may be too large, the type of block may be classified, and the NN parameters are shared between only the blocks within the same class. For example, the norm length of the feature vector may be used as a measure for classifying different blocks.

For the (b−1)-th block, the surface reconstruction process 714 takes as inputs the feature vector \hat{F}_{b-1} 704 and the (b−1)-th block grid points P_{G,b-1} 706 to generate the (b−1)-th block of upsampled local 3D grid points

$${\hat{P}}_{g , b - 1}^{L}$$

718. T transform this local surface to the global 3D space, the (b−1)-th block coordinate Ĉ_{b-1} 722 is added (⊕ operation) to every local grid point

$${\hat{P}}_{g , b - 1}^{L}$$

718 for g=1 . . . N_{G} the (b−1)-th block of upsampled 3D grid points \hat{P}_{G,b-1} 726.

Similarly, for the b-th block, the surface reconstruction process 716 takes as inputs the feature vector \hat{F}_{b} 710 and the b-th block grid points P_{G,b}, 708 to generate the b-th block of upsampled local 3D grid points

$${\hat{P}}_{g , b}^{L}$$

720. To transform this local surface to the global 3D space, the b-th block coordinate Ĉ_{b} 724 is added (⊕ operation) to every local grid point

$${\hat{P}}_{g , b}^{L}$$

720 for g=1 . . . N_{G} to generate the b-th block of upsampled 3D grid points \hat{P}_{G,b} 728.

The (b−1)-th block of upsampled 3D grid points \hat{P}_{G,b-1} 726 and the b-th block of upsampled 3D grid points \hat{P}_{G,b} 728 are shown in a 3D space 730.

### Six-Dimensional (6D) Pose Estimation

The point cloud within a block before the downsample mostly forms a shape of the surface. This situation is more likely if the point cloud is denser or generated for an immersive application. The estimated orientation of this surface in a block may be heading in different directions. This condition makes the feature coding task more challenging, especially for surface reconstruction. Therefore, aligning this orientation is helpful to improve the coding gain due to the reduction of dimensionality.

### Block Alignment

In accordance with some embodiments, the principal component analysis (PCA) is a mathematical tool that may help align different orientations. In accordance with some embodiments, an alignment in the encoder may be required and as such, an example required alignment in the encoder may be, e.g., defined in two steps: (1) re-centering a group of points through translation; then (2) alignment of the block points through rotation.

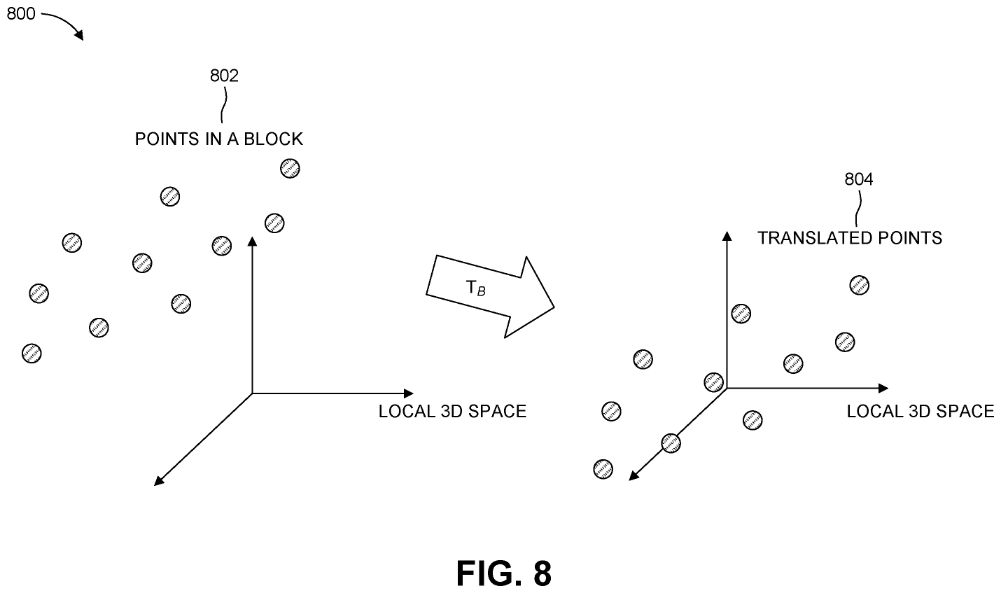

FIG. 8 is a schematic illustration showing an example translation of the center of block points to the origin of a local 3D space according to some embodiments. In FIG. 8, the first translation (shifting) step is illustrated. The dots are a group of points belonging to a block. The center of the points on the left 802 is determined (e.g., calculated), then shifted towards the center of local 3D space 804 via a translation vector T_{B}

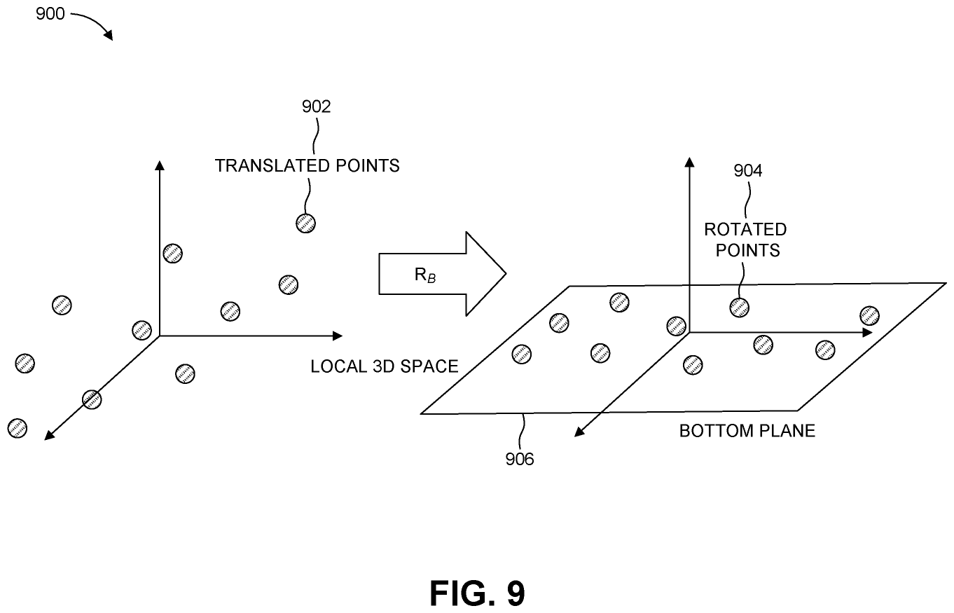

FIG. 9 is a schematic illustration showing an example rotation of translated points towards the axes of a local 3D space according to some embodiments. In the second step, which is shown in FIG. 9, the re-centered (translated) block points 902, which has the shape of a surface, is aligned to the bottom plane of the local 3D space. The three principal components computed from PCA analysis may formulate a rotation matrix R_{B} for this alignment to generate rotated points 904. PCA is a technique that analyzes a set of orthogonal axes, called principal components, that capture the maximum variance in the data, which is the position of the point cloud for this application. The principal components are ordered in decreasing order from the principal (“most important”) axis. The three first components form an orthonormal matrix representing the rotation matrix R_{B}. This matrix may be used to align a group of points to a 2D plane.

For some embodiments, a PCA is an example of a “dimensionality reduction technique.” The dimensionality may be reduced, in which the analysis identifies the components in the order of importance, letting a data analyst choose some of these components.

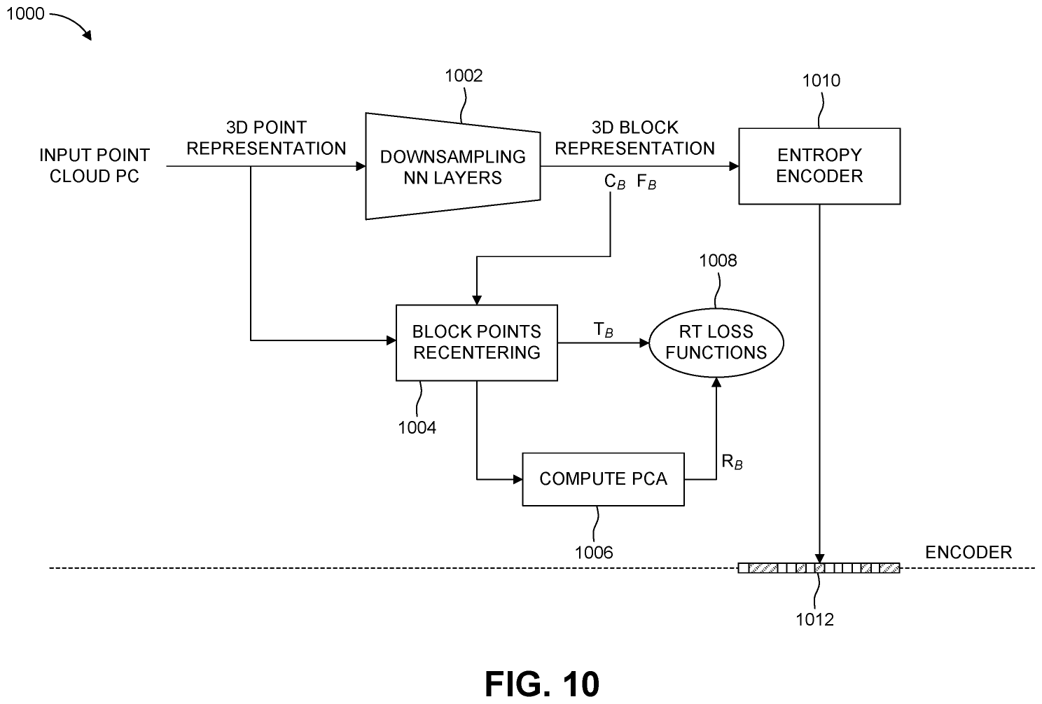

FIG. 10 is a process diagram illustrating an example determination of block surface alignment ground truth for a training process according to some embodiments. In a PCC encoder framework 1000, an input point cloud is downsampled 1002 and then passed through an entropy encoder 1010 to generate the output bitstream 1012.

In the PCC encoder framework 1000, block alignment steps may be achieved with the Block Points Recentering block 1004 and the Compute PCA block 1006 of FIG. 10, which output T_{B} and R_{B} (6D pose), respectively. The translation vector T_{B} and the rotation matrix R_{B} are the ground truth 6D pose to be learned from the decoder. The RT loss functions (rotation and translation losses) 1008 take this ground truth to supervise block alignment in an end-to-end manner.

For some embodiments, some deterministic blocks are used to compute a shifting vector or orientation matrix to supervise (via the RT loss functions) 6D pose estimation during the training stage.

### FORT-Net Decoder

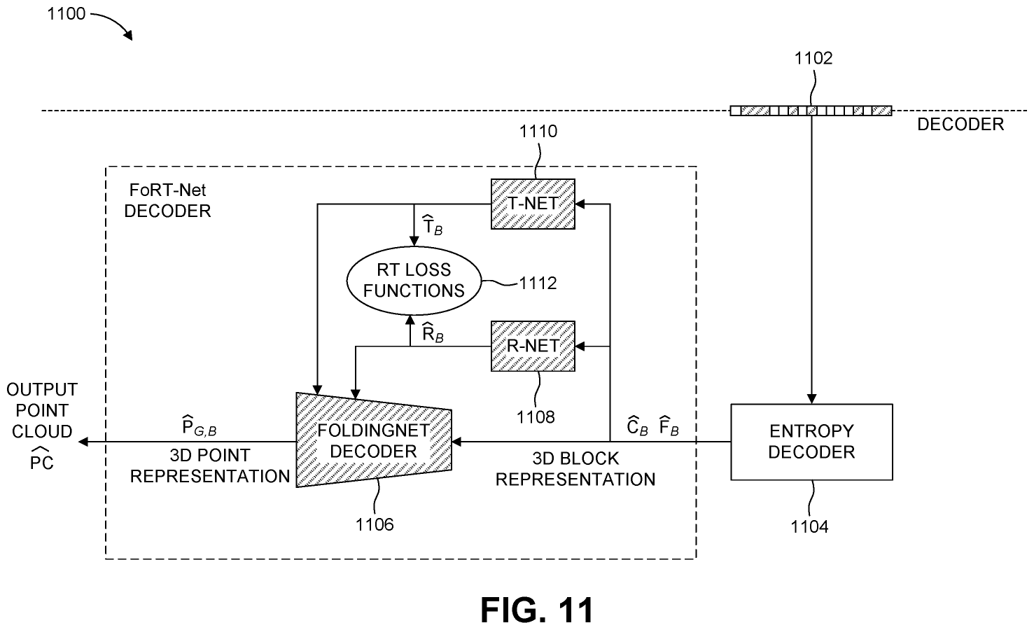

FIG. 11 is a process diagram illustrating an example rotation/translation decoder framework with an example surface reconstruction framework, for example a FORT-Net decoder framework, according to some embodiments. In the decoder framework 1100, bitstream 1102 is received and passed through an entropy decoder 1104 to generate the reconstructed feature map \hat{F}_{B} with the b-th block position (or coordinate) Ĉ_{b}.

In the decoder framework 1100, as illustrated in FIG. 11, two neural networks, e.g., example rotational network R-Net 1108 and example translational network T-Net 1110, are designed in parallel with the FoldingNet decoder 1106. The two neural networks, R-Net 1108 and T-Net 1110, learn how to estimate the 6D pose, T_{B} and R_{B} of each decoded block that are computed in the encoder. The R-Net and T-Net blocks both take the reconstructed feature map \hat{F}_{B} as input and output \hat{R}_{B} and \hat{T}_{B}, respectively, where \hat{R}_{B} is an array of 3×3 rotation matrices of each block and \hat{T}_{B} is an array of 3D vectors of each block. This enhanced point cloud decoding architecture entitled FORT-Net decodes the local surface more efficiently by estimating the surface alignment of each block. Each estimated \hat{R}_{B} and \hat{T}_{B} are fed to the FoldingNet decoder 1106 and to the RT loss computation 1112.

The FoldingNet and FORT-Net decoders are examples of learning-based surface reconstruction decoders. An R-Net block is an example of a rotation (or orientation) estimation network. A T-Net block is an example of a translation (or shift vector) estimation network. A FORT-Net decoder is a combination or mix of a FoldingNet decoder, an R-Net block, and a T-Net block. For some embodiments, rotational/translational decoders make a learning-based surface reconstruction decoder, such as a FORT-Net decoder, more efficient.

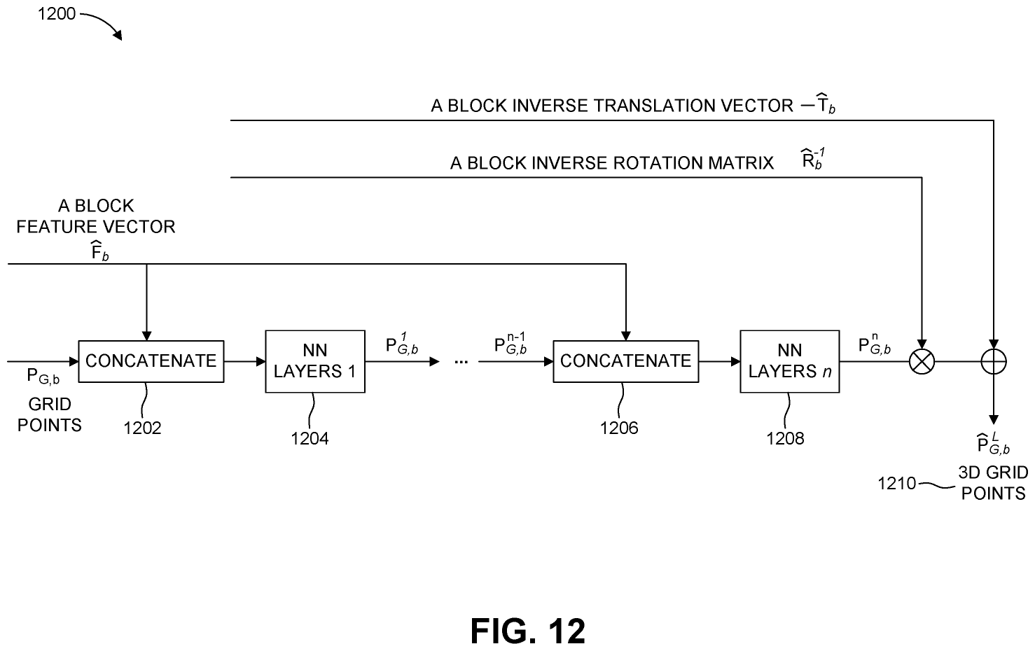

FIG. 12 is a process diagram illustrating an example block-wise surface reconstruction with inversed block alignment according to some embodiments.

In the surface reconstruction block process 1200, a series of neural network (NN) layers 1204, 1208 are connected sequentially. As illustrated in FIG. 12, for each step, the block feature vector \hat{F}_{b} is concatenated 1202, 1206 with the grid points and refines the grid points via a set of NN layers.

As illustrated in FIG. 12, the surface reconstruction block process 1200 in the FoldingNet decoder applies the given Ry and Ty to improve the coding gain, where the index b indicates a specific b—the block. At the final surface approximation step, the inverse of the estimated b-the block rotation matrix

$$( {\hat{R}}_{b}^{- 1} )$$

multiplied (⊕) by each approximated 3D grid point. Then, the estimated b-the block translation vector Ty is subtracted from the input 3D grid points to generate the 3D grid points

$${\hat{P}}_{G , b}^{L}$$

1210. This inverse RT operations bring back the reconstructed surface to the state before the alignment, forcing the previous sets of NN layers to learn reconstruction from the aligned local surfaces. For some embodiments, an inverse matrix computation block

$$( for {\hat{R}}_{b}^{- 1} )$$

may be added to the process shown in FIG. 12.

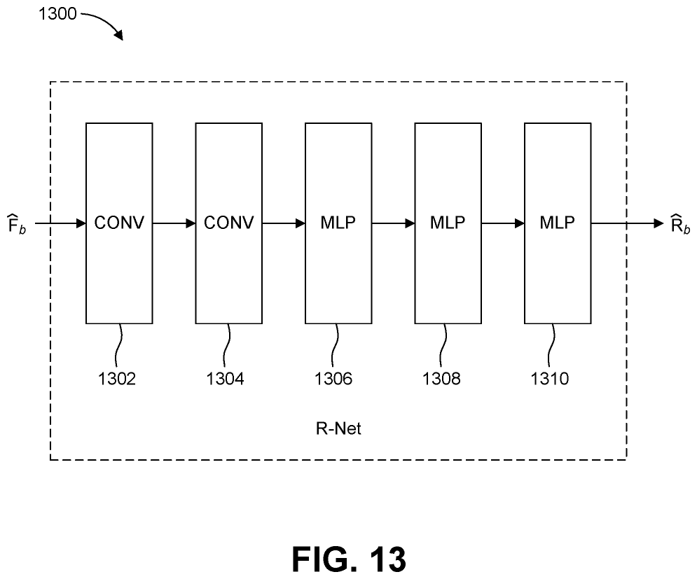

FIG. 13 is a process diagram illustrating an example R-Net block according to some embodiments. As shown in FIG. 13, an example R-Net block 1300 includes two convolutional layers 1302, 1304, then three MLP layers 1306, 1308, 1310, which output an array of 9 dimensional vectors representing rotation matrices per block. The dimensions of these five layers in FIG. 13 are (64, 128, 64, 32, 9), so that each feature vector \hat{F}_{b} leads to 3×3 rotation matrix for the corresponding block b.

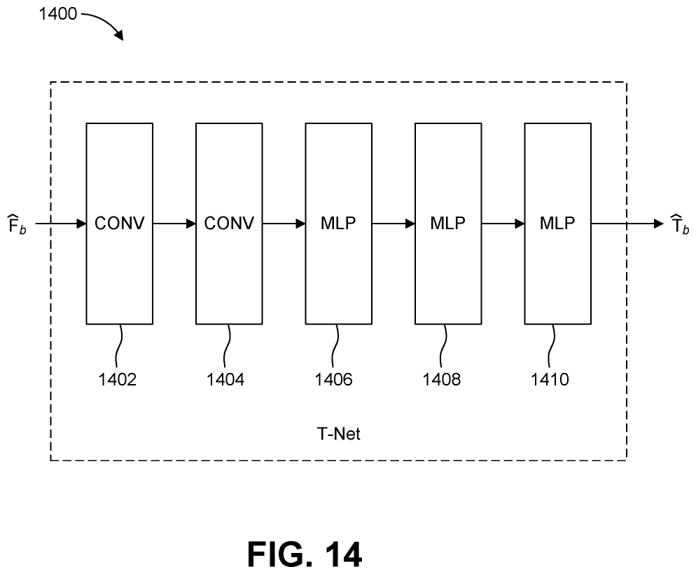

FIG. 14 is a process diagram illustrating an example T-Net block according to some embodiments. As shown in FIG. 14, an example T-Net block 1400 is similar to the R-Net block of FIG. 13. The T-Net block 1400 outputs an array of 3 dimensional vectors representing translation vectors per block. The example T-Net block 1400 includes two convolutional layers 1402, 1404 and three MLP layers 1406, 1408, 1410. The dimensions of these five layers in FIG. 14 are (64, 128, 64, 32, 3) so that each feature vector \hat{F}_{B} leads to translation vector for the corresponding block b.

In the R-Net and T-Net, convolutional layers and MLP may be used as micro-architectures for an elementary design of the proposed functional architecture. They may be replaced, appended, or squeezed with advanced feature aggregation micro-architectures, such as Inception ResNets (IRNs) according to Szegedy, C., et al., Inception-v4, Inception-ResNet and the Impact of Residual Connections on Learning, 31:1 PROC. OF AAAI CONF. ON ARTIFICIAL INTELLIGENCE (2017) (“Szegedy”).

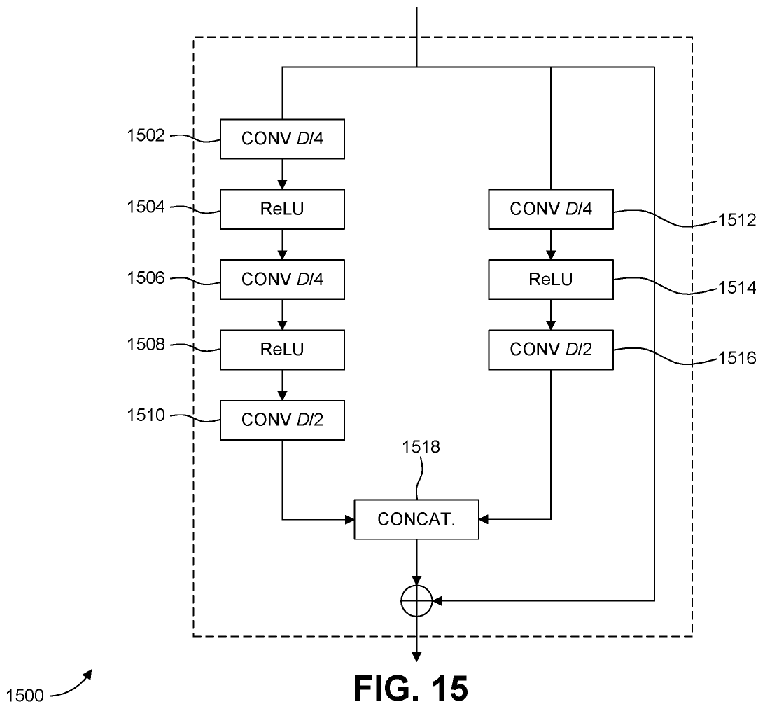

FIG. 15 is a process diagram illustrating an example Inception-ResNet block for feature aggregation according to some embodiments. The IRN architecture 1500 provided in FIG. 15 shows the architecture of an IRN block to aggregate features with D channels. Here “CONV N” means a convolutional layer which accepts an input with N channels, and “⊕” denotes summation.

A feature map may enter the IRN architecture 1500 at the top of the figure and be split into two parallel paths. The left path goes through a convolutional layer D/4 1502 followed by a rectifier linear unit (ReLU) 1504 and then another convolutional layer D/4 1506 followed by a rectifier linear unit (ReLU) 1508 and a convolutional layer D/2 1510. The right path goes through a convolutional layer D/4 1512 followed by a rectifier linear unit (ReLU) 1514 and a convolutional layer D/2 1516. The outputs of the two convolutional layer D/2 blocks 1510, 1516 are concatenated 1518 to generate the output of the IRN architecture 1500.

As an example, the process shown in FIG. 15 may be used as a part of the R-Net or T-Net processes shown in FIGS. 13 and 14, respectively. The entire example process of FIG. 15. may be added to FIG. 14, for example, between the convolution (CONV) layers 1402, 1404.

In some embodiments, a deep distribution aware network may replace the IRN to enhance the feature. See Ahn, J., et al., DDA-Net: Deep Distribution-Aware Network for Point Cloud Compression, 2023 IEEE INTERNATIONAL SYMPOSIUM ON CIRCUITS AND SYSTEMS (ISCAS) (2023) (“Ahn”) for a description of a deep distribution aware network.

### RT Loss Function

To estimate \hat{R}_{B} and \hat{T}_{B}, the R loss [symbol] _{R} and the T loss L_{T} functions are defined then added to compute an RT loss. The definition of the L2 norm L_{R} is as shown in Eq. 1:

$${ℒ}_{R} = {‖ {R}_{B} \cdot {\hat{R}}_{B}^{T} - I ‖}_{2} \qquad ( 1 )$$

where

$${\hat{R}}_{B}^{T}$$

is the transpose of the estimated rotation matrices outputted from the R-Net. The I is an identity matrix. The L2 norm L_{T} is defined as shown in Eq. 2:

$${ℒ}_{T} = {‖ {T}_{B} - {\hat{T}}_{B} ‖}_{2} \qquad ( 2 )$$

Based on the above losses, the RT loss L_{RT} is defined as shown in Eq. 3:

$${ℒ}_{RT} = {ℒ}_{R} + {ℒ}_{T} \qquad ( 3 )$$

The L_{RT} loss term is added to the rate-distortion optimization function to resolve the supervision of block alignment in an end-to-end manner.

Among various types of point clouds, a dense surface point cloud is one of the most common ways of representing 3D objects in an immersive environment. A specific decoding method may be specified for this type of point cloud. A FoldingNet architecture has been referred to in many works to resolve this issue, but not in an AI-based point cloud compression (PCC) framework. A FoldingNet-based network may be used to synthesize a point cloud surface. The reconstruction quality may be improved by estimating the 6D pose (rotation and translation) of local points. This decoding block may be flexibly connected to any upsampling part in a PCC decoder. Such a point-based design may avoid the over-smoothing effect typically observed in a CNN-based architecture. According to experimental results, the point-based method improves coding performance on both voxel- and point-based PCC architectures by replacing the upsampling blocks with processes described herein.

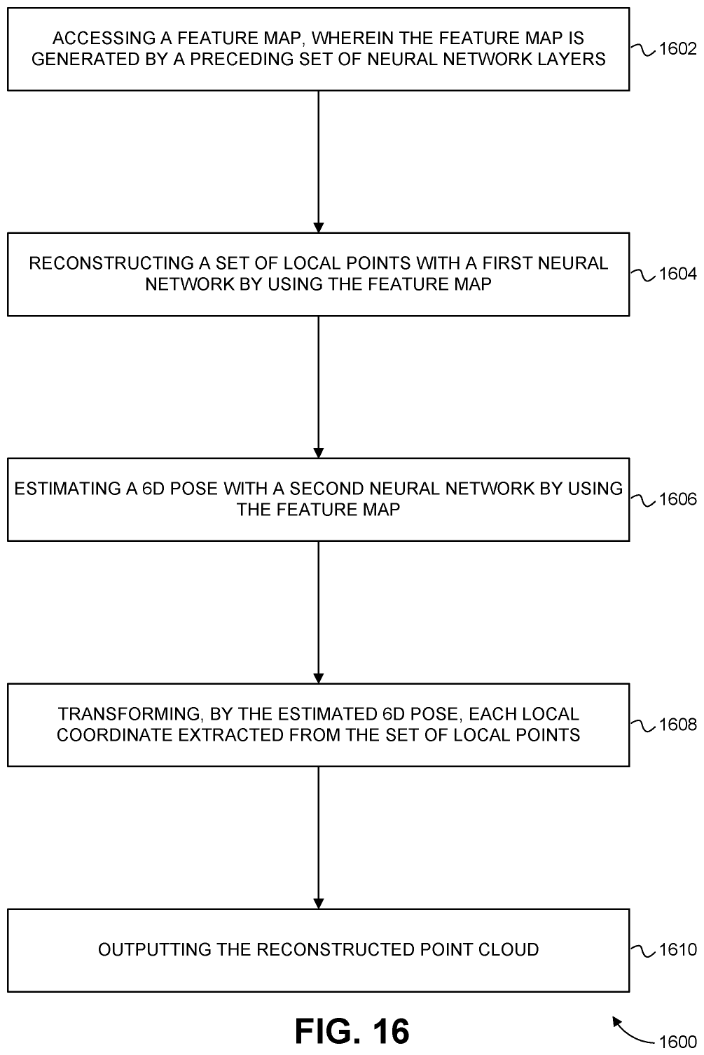

FIG. 16 is a flowchart illustrating an example process for reconstructing a point cloud according to some embodiments. For some embodiments, an example process 1600 may include accessing 1602 a feature map, wherein the feature map is generated by a preceding set of neural network layers. For some embodiments, the example process 1600 may further include reconstructing 1604 a set of local points with a first neural network by using the feature map. For some embodiments, the example process 1600 may further include estimating 1606 a 6D pose with a second neural network by using the feature map. For some embodiments, the example process 1600 may further include transforming 1608, by the estimated 6D pose, each local coordinate extracted from the set of local points. For some embodiments, the example process 1600 may further include outputting 1610 the reconstructed point cloud.

An example apparatus in accordance with some embodiments may include at least one processor configured to perform any one of the methods described within this application. An example apparatus in accordance with some embodiments may include a computer-readable medium storing instructions for causing one or more processors to perform any one of the methods described within this application. An example apparatus in accordance with some embodiments may include at least one processor and at least one non-transitory computer-readable medium storing instructions for causing the at least one processor to perform any one of the methods described within this application. An example signal in accordance with some embodiments may include a bitstream generated according to any one of the methods described within this application.

While the methods and systems in accordance with some embodiments are generally discussed in context of extended reality (XR), some embodiments may be applied to any XR contexts such as, e.g., virtual reality (VR)/mixed reality (MR)/augmented reality (AR) contexts. Also, although the term “head mounted display (HMD)” is used herein in accordance with some embodiments, some embodiments may be applied to a wearable device (which may or may not be attached to the head) capable of, e.g., XR, VR, AR, and/or MR for some embodiments.

A first example method in accordance with some embodiments may include: accessing a feature map, wherein the feature map is generated by a preceding set of neural network layers; reconstructing a set of local points with a first neural network by using the feature map; estimating a 6D pose with a second neural network by using the feature map; transforming, by the estimated 6D pose, each local coordinate extracted from the set of local points; and outputting the reconstructed point cloud.

For some embodiments of the first example method, the feature map is a block feature map, estimating the 6D pose includes estimating the 6D pose on a per block basis, and transforming each extracted local coordinate includes transforming the 6D pose on a per block basis.

For some embodiments of the first example method, the first neural network is a learning-based surface reconstruction-type neural network.

For some embodiments of the first example method, reconstructing the set of local points includes: selecting a first set from a group of grid points; repeating a loop based on a quantity of points in the feature map: concatenating the first set and a subset of a block feature vector to generate a concatenated set of points; and passing the concatenated set of points through the first neural network to generate the first set for a next pass through the loop; and outputting, as the set of local points, the first set from a last pass through the loop.

For some embodiments of the first example method, estimating the 6D pose includes: estimating, for each block of the plurality of blocks associated with the feature map, an array of translational matrices; and estimating, for each block of a plurality of blocks associated with the feature map, an array of rotational matrices.

For some embodiments of the first example method, transforming each local coordinate extracted from the set of local points includes: translating at least one of the local points using the array of translational matrices; and rotating at least one of the local points using the array of rotational matrices.

For some embodiments of the first example method, transforming each local coordinate extracted from the set of local points includes: re-centering, using the array of translational matrices, at least one of the local points; and aligning, using the array of rotational matrices, at least of the local points.

Some embodiments of the first example method may further include determining a loss function using at least one of the array of translational matrices and the array of rotational matrices.

For some embodiments of the first example method, estimating the array of translational matrices includes: performing at least one convolutional layer process on the feature map; and performing at least one multi-layer perceptron (MLP) process on an output of the at least one convolutional layer process to output the array of translational matrices.

For some embodiments of the first example method, estimating the array of rotational matrices includes: performing at least one convolutional layer process on the feature map; and performing at least one multi-layer perceptron (MLP) process on an output of the at least one convolutional layer process to output the array of rotational matrices.

For some embodiments of the first example method, estimating the array of translational matrices includes using a translation estimation process.

For some embodiments of the first example method, estimating the array of rotational matrices includes using a rotation estimation process.

For some embodiments of the first example method, estimating the 6D pose includes performing a dimensionality reduction technique.

Some embodiments of the first example method may further include entropy decoding a bitstream to generate the feature map.

Some embodiments of the first example method may further include performing a feature aggregation process on the feature map.

For some embodiments of the first example method, the feature aggregation process includes: performing at least one convolutional layer process; and performing at least one rectifier linear unit (ReLU) process.

A first example apparatus in accordance with some embodiments may include: a processor; and a memory, the memory storing instructions operative, when executed by the processor, to cause the apparatus to: access a feature map, wherein the feature map is generated by a preceding set of neural network layers; reconstruct local points with a first neural network by using the feature map; estimate a 6D pose with a second neural network by using the feature map; transform, by the estimated 6D pose, each local coordinate extracted from the set of local points; and output the reconstructed point cloud.

A second example method in accordance with some embodiments may include: entropy decoding a bitstream to obtain a feature map; performing a surface reconstruction to generate a set of local points using the feature map; estimating a 6D pose with a neural network by using the feature map; transforming, by the estimated 6D pose, each local point extracted from the set of local points; and outputting the reconstructed point cloud.

For some embodiments of the second example method, the feature map is a block feature map, estimating the 6D pose includes estimating the 6D pose on a per block basis, and transforming each extracted local coordinate includes transforming the 6D pose on a per block basis.

For some embodiments of the second example method, the neural network is a learning-based surface reconstruction-type neural network.

This disclosure describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the disclosure or scope of those aspects. Indeed, all of the different aspects can be combined and interchanged to provide further aspects. Moreover, the aspects can be combined and interchanged with aspects described in earlier filings as well.

Various numeric values may be used in the present disclosure, for example. The specific values are for example purposes and the aspects described are not limited to these specific values.

Embodiments described herein may be carried out by computer software implemented by a processor or other hardware, or by a combination of hardware and software. As a non-limiting example, the embodiments can be implemented by one or more integrated circuits. The processor can be of any type appropriate to the technical environment and can encompass one or more of microprocessors, general purpose computers, special purpose computers, and processors based on a multi-core architecture, as non-limiting examples.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this disclosure are not necessarily all referring to the same embodiment.

Additionally, this disclosure may refer to “determining” various pieces of information. Determining the information can include one or more of, for example, estimating the information, calculating the information, predicting the information, or retrieving the information from memory.

Further, this disclosure may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this disclosure may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as are listed.

Implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method comprising:
accessing a feature map,
wherein the feature map is generated by a preceding set of neural network layers;
reconstructing a set of local points with a first neural network by using the feature map;
estimating a six-dimensional (6D) pose with a second neural network by using the feature map;
transforming, by the estimated 6D pose, each local coordinate extracted from the set of local points; and
outputting the reconstructed point cloud.

2. The method of claim 1,
wherein the feature map is a block feature map,
wherein estimating the 6D pose comprises estimating the 6D pose on a per block basis, and
wherein transforming each extracted local coordinate comprises transforming the 6D pose on a per block basis.

3. The method of claim 1, wherein the first neural network is a learning-based surface reconstruction-type neural network.

4. The method of claim 1, wherein reconstructing the set of local points comprises:
selecting a first set from a group of grid points;
repeating a loop based on a quantity of points in the feature map:
concatenating the first set and a subset of a block feature vector to generate a concatenated set of points; and
passing the concatenated set of points through the first neural network to generate the first set for a next pass through the loop; and
outputting, as the set of local points, the first set from a last pass through the loop.

5. The method of claim 1, wherein estimating the 6D pose comprises:
estimating, for each block of the plurality of blocks associated with the feature map, an array of translational matrices; and
estimating, for each block of a plurality of blocks associated with the feature map, an array of rotational matrices.

6. The method of claim 5, wherein transforming each local coordinate extracted from the set of local points comprises:
translating at least one of the local points using the array of translational matrices; and
rotating at least one of the local points using the array of rotational matrices.

7. The method of claim 5, wherein transforming each local coordinate extracted from the set of local points comprises:
re-centering, using the array of translational matrices, at least one of the local points; and
aligning, using the array of rotational matrices, at least of the local points.

8. The method of claim 5, further comprising:
determining a loss function using at least one of the array of translational matrices and the array of rotational matrices.

9. The method of claim 5, wherein estimating the array of translational matrices comprises:
performing at least one convolutional layer process on the feature map; and
performing at least one multi-layer perceptron (MLP) process on an output of the at least one convolutional layer process to output the array of translational matrices.

10. The method of claim 5, wherein estimating the array of rotational matrices comprises:
performing at least one convolutional layer process on the feature map; and
performing at least one multi-layer perceptron (MLP) process on an output of the at least one convolutional layer process to output the array of rotational matrices.

11. The method of claim 5, wherein estimating the array of translational matrices comprises using a translation estimation process.

12. The method of claim 5, wherein estimating the array of rotational matrices comprises using a rotation estimation process.

13. The method of claim 1, wherein estimating the 6D pose comprises performing a dimensionality reduction technique.

14. The method of claim 1, further comprising entropy decoding a bitstream to generate the feature map.

15. The method of claim 1, further comprising performing a feature aggregation process on the feature map.

16. The method of claim 15, wherein the feature aggregation process comprises:
performing at least one convolutional layer process; and
performing at least one rectifier linear unit (ReLU) process.

17. An apparatus comprising:
a processor; and
a memory, the memory storing instructions operative, when executed by the processor, to cause the apparatus to:
access a feature map,
wherein the feature map is generated by a preceding set of neural network layers;
reconstruct local points with a first neural network by using the feature map;
estimate a 6D pose with a second neural network by using the feature map;
transform, by the estimated 6D pose, each local coordinate extracted from the set of local points; and
output the reconstructed point cloud.

18. A method comprising:
entropy decoding a bitstream to obtain a feature map;
performing a surface reconstruction to generate a set of local points using the feature map;
estimating a 6D pose with a neural network by using the feature map;
transforming, by the estimated 6D pose, each local point extracted from the set of local points; and
outputting the reconstructed point cloud.

19. The method of claim 18,
wherein the feature map is a block feature map,
wherein estimating the 6D pose comprises estimating the 6D pose on a per block basis, and
wherein transforming each extracted local coordinate comprises transforming the 6D pose on a per block basis.

20. The method of claim 18, wherein the neural network is a learning-based surface reconstruction-type neural network.
